(19) United States
(12) Patent Application Publication
(10) Pub. No.: US 2021/0146175 A1
(43) Pub. Date: May 20, 2021

(54) Fire Suppression Device and System

(71) Applicant: They, Galveston, TX (US)

(72) Inventor: They, Galveston, TX (US)

(21) Appl. No.: 16/688,431

(22) Filed: Nov. 19, 2019

(51) Int. Cl. A62C 2/06; A62C 99/00

(52) U.S. Cl. CPC A62C 3/14; A62C 99/0072

(57) ABSTRACT

Provided herein are a fire suppression device or control device for putting out a fire using a high pressure water and air-line to propel and diffuse the water as a mist towards the flames. The device has a cylindrical pipe with a diffuser nozzle on one end, a Y-connector on the other end, shutoff valves that regulate the flow of water and air to the nozzle, and at least one hook disposed on the device to brace or anchor the device to a wall. Also provided is a barrier-penetrating fire suppression system with a penetrator assembly mounted on a vehicle platform boom. The penetrator assembly is perpendicularly aligned with a barrier whereupon a striker shaft propels a piercing nozzle through a barrier before water is sprayed from the nozzle.

### BACKGROUND OF THE INVENTION

### Field of the Invention

The invention relates to the field of fire control, suppression and extinguishment. More specifically, the present invention is directed to a fire suppression device and system for manual use or for use on a fire truck.

### Description of the Related Art

Fire suppression systems are used to extinguish fires or prevent the spread of fire. Suppression systems comprise water or a combination of dry chemicals and/or wet agents depending on the origin of the fire. Water has by far been the most commonly used agent for bringing fires under control. The water is delivered to the fire using many systems including, automatic or remotely operated sprinkler systems installed in buildings and a fire hose that is operated by fire safety personal. In the later case, a breach in the wall, door, roof or window barrier needs to be made before the hose is used to direct a water jet in the direction of the fire.

Fire control using a jet of water while convenient requires significant consumption of water most of which is wasted. Further, the excess of water damages and weakens building structure. Personal property is also damaged and in many cases is not replaceable thereby adding to the emotional and financial toll.

Thus there is a recognized need in the art for fire suppression devices that improve the efficiency in suppressing fires while reducing water usage. The present invention fulfills this longstanding need and desire in the art.

### SUMMARY OF THE INVENTION

The present invention is directed to a fire suppression device. The fire suppression device comprises a pipe with a proximal end and a distal end. In the device diffuser is removably attached to and in fluid communication with the proximal end of the pipe and a first shutoff valve is disposed in fluid communication with the pipe distal to the diffuser. At least one hook is attached to the pipe between the diffuser and the shutoff valve. A Y-connector is formed at the distal end of the pipe comprising an inlet coupled to each arm of the Y-connector and in fluid communication therewith.

The present invention is directed to a related fire suppression device further comprising a second shutoff valve disposed in fluid communication with each inlet coupled to the arm of the Y-connector or with each arm thereof. The present invention is directed to another related fire suppression device further comprising a handle depending from the pipe between the shutoff valve and the Y-connector.

The present invention also is directed to another fire control device. In fluid communication in the device is a diffuser section with a proximal and distal end, a shutoff valve and grip combination with a proximal end disposed at the distal end of the diffuser section and a distal end and a Y-connector with a proximal end disposed at the distal end of the shutoff valve and grip combination and a distal end.

The present invention is directed further to a barrier-penetrating fire suppression system. The barrier-penetrating fire suppression system comprises a penetrator assembly and a boom arm and piston combination mounted to the penetrator assembly and to a vehicle platform boom. The penetrator assembly has an injector head comprising a hollow interior portion with an open proximal front end and an open distal back end disposed transversely therewithin and a penetrator driver motor disposed on the injector head. A hollow striker shaft with an open proximal end and an open distal end is disposed within the hollow interior portion of the injector head and in a mechanical relationship with the penetrator driver motor such that the hollow striker shaft extends from both the open proximal front end and from the open distal back end thereof. A piercing nozzle is in fluid communication with the open proximal end of the hollow striker shaft and removably attachable therefrom. A manifold is in fluid communication with the open distal end of the hollow striker shaft. The boom arm and piston combination is mounted to the injector head at proximal ends thereof and to the vehicle platform boom at distal ends thereof where the arm and piston combination is electrically operable.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1C show the different embodiments of the fire suppression device.

FIGS. 2A-2D shows the features of a penetrator assembly of a barrier-penetrating fire suppression system. FIG. 2A is a side view of the penetrator assembly attached to an arm of a vehicle platform boom, in a retracted position when not in use. FIG. 2B is a cross-sectional view of the injector head. FIG. 2C is a side view showing the penetrator assembly in a deployed position. FIG. 2D illustrates spraying a mist of water and air from the deployed penetrator assembly of FIG. 2C.

### DETAILED DESCRIPTION OF THE PRESENT INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

As used herein, terms “comprise” and “comprising” are used in the inclusive, open sense, meaning that additional elements may be included.

As used herein, term “including” is used herein to mean “including, but not limited to”. “Including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In a non-limiting example, when referring to the dimensions of the components of the fire suppression systems disclosed herein, an inner bore diameter of 34.3 mm or 279.4 mm are considered within the scope of about 38.1 mm and about 254 mm degrees, respectively. Correspondingly, a water pressure and/or gas pressure of 450 psi and 1,100 psi are considered within the scope of about 500 psi to about 1,000 psi.

As used herein, the terms “proximal” and “distal” in reference to the fire suppression systems disclosed herein refer to those components, features, parts and aspects thereof that are nearer or nearest to or farther or farthest from the nozzle, the diffuser nozzle and the piercing nozzle, respectively.

As used herein, the terms “front” and “back” refer to those components, features, parts and aspects thereof that face toward or face away from a barrier, a structure, or a window, etc. when the device or system is in use

As used herein, the term “rigid” refers to the structural characteristic of retaining shape even when not under pressure from water and/or gas flow therethrough, e.g. a hose, fire hose, water inlet line, and gas inlet line.

In one embodiment of the present invention, there is provided a fire suppression device comprising a pipe with a proximal end and a distal end; a diffuser removably attached to and in fluid communication with the proximal end of the pipe; a first shutoff valve disposed in fluid communication with the pipe distal to the diffuser; at least one hook attached to the pipe between the diffuser and the shutoff valve; and a Y-connector formed at the distal end of the pipe comprising an inlet coupled to each arm of the Y-connector and in fluid communication therewith.

Further to this embodiment, the fire control device may comprise a second shutoff valve disposed in fluid communication with each inlet coupled to the arm of the Y-connector or with each arm thereof. In another further embodiment, the fire control device may comprise a handle depending from the pipe between the shutoff valve and the Y-connector. In addition, each inlet may have an inner bore with a diameter equal to the diameter of the inner bore of the pipe. Furthermore, one inlet may be a water inlet and the other inlet may be an air inlet. Further still, the device may be constructed from a material that withstands a pressure of about 500 psi to about 1,000 psi.

In another embodiment of the present invention, there is provided a fire control device comprising in fluid communication a diffuser section with a proximal and distal end; a shutoff valve and grip combination with a proximal end disposed at the distal end of the diffuser section and a distal end; and a Y-connector with a proximal end disposed at the distal end of the shutoff valve and grip combination and a distal end.

In this embodiment, the diffuser section may comprise a cylindrical pipe comprising a proximal end and a distal end; a diffuser nozzle removably attached to and in fluid communication with the proximal end of the cylindrical pipe; and a plurality of hooks attached circumferentially to the cylindrical pipe. Further to this embodiment the fire control device may comprise a plurality protective strips disposed along the cylindrical pipe between the plurality of hooks and the shutoff valve and grip combination. In another further embodiment, the diffuser nozzle may comprise a venturi disposed therein. In all embodiments the cylindrical pipe may have an inner bore with a diameter of about 38.1 mm to about 254 mm.

Also in this embodiment, the Y-connector may comprise a coupler attached to proximal end thereof and a coupler attached to the distal end of each arm of the Y-connector; an inlet with a coupler attached to a proximal end thereof removably coupled with the coupler at the distal end of each arm of the Y-connector and in fluid communication therewith; and a second shutoff valve disposed on each arm of the Y-connector and in fluid communication therewith.

In one aspect of this embodiment, the diffuser section further comprises a coupler attached at the distal end thereof and the shutoff valve and grip combination comprises a first shutoff valve disposed in fluid communication between the diffuser section and the Y-connector and a coupler attached at the proximal end thereof and a coupler attached at the distal end thereof, said shutoff valve and grip combination coupled with the coupler at the distal end of the diffuser section and at the proximal end of the Y-connector.

In another aspect of this embodiment, the shutoff valve and grip combination comprises a first shutoff valve disposed in fluid communication between the diffuser section and the Y-connector and a coupler attached at the distal end thereof, where the shutoff valve and grip combination is in direct fluid contact with the distal end of the diffuser section and is coupled with the coupler at the proximal end of the Y-connector.

In this embodiment and aspects thereof, each inlet may have an inner bore with a diameter equal to the diameter of the inner bore of the pipe. Also in this embodiment and aspects thereof, one inlet may be a water inlet and the other inlet may be an air inlet.

In yet another embodiment of the present invention, there is provided a barrier-penetrating fire suppression system comprising a penetrator assembly comprising an injector head comprising a hollow interior portion with an open proximal front end and an open distal back end disposed transversely therewithin; a penetrator driver motor disposed on the injector head; a hollow striker shaft with an open proximal end and an open distal end disposed within the hollow interior portion of the injector head and in a mechanical relationship with the penetrator driver motor, said hollow striker shaft extending from both the open proximal front end and from the open distal back end thereof; a piercing nozzle in fluid connection with the open proximal end of the hollow striker shaft and removably attachable therefrom; and a manifold in fluid communication with the open distal end of the hollow striker shaft; and a boom arm and piston combination removably mounted to the injector head at proximal ends thereof and attached to a vehicle platform boom at distal ends thereof where the boom arm and piston combination are electrically operable. In this embodiment, penetrator assembly is constructed from a material that withstands a pressure of about 500 psi to about 1,000 psi.

In this embodiment, the hollow striker shaft may comprise a gear drive disposed therein and coupled with the penetrator driver motor; a linear gear track interiorly disposed along the hollow striker shaft and engaged with the gear drive; and a hollow delivery line disposed therewithin with a proximal end in fluid communication with the piercing nozzle and a distal end in fluid communication with the manifold. Particularly, the hollow delivery line may have an inner bore diameter of about 38.1 mm to about 254 mm.

Related to this embodiment. the piercing nozzle may comprise a proximal end adapted to pierce a barrier; and a plurality of nozzle ports disposed circumferentially thereon in fluid communication with the hollow delivery line. In this embodiment the barrier may be a wall, a roof or a window. In a further related embodiment the manifold may comprise a pair of feed lines each with a proximal end in fluid communication therewith and each removably attachable thereto. In this further related embodiment. one of the pair of feed lines may be a water feed line and the other of the pair of feed lines may be an air feed line.

Provided herein are fire control devices and fire suppression devices for delivery of fire retardants or suppressors, for example, fluids such as water and a fire retardant gas. Generally, these devices comprise in fluid communication a central portion or section, for example, a pipe, with a diffuser or diffuser section attached at or coupled to a proximal end and a Y-connector formed from or coupled to the distal end. A pair of inlets is removably coupled with or removably connected to the arms of the Y-connector in fluid communication, that is, one inlet of the pair coupled to one arm and the other inlet coupled to the other arm. The components of any devices described herein are made of a material or combination of materials adapted to sustain a pressure from about 500 psi to about 1,000 psi as are known in the art. Means for coupling the components may be any couplers known and standard in the art mechanically or structurally effective to withstand these pressures.

The central portion or section has at least one hook attached thereon distal to the diffuser nozzle. A single hook may be attached to and depend from the exterior bottom surface of the central portion or central section. Alternatively, one or two pairs of hooks are circumferentially disposed on the exterior surface such that one hook or two hooks extend upwardly from the top surface and the other one or two hooks depend downwardly. All hooks disposed on the device have an equal length of about 2 in. to about 10 in. and are braced against an interior surface of a barrier through an opening therethrough, for example, a window, or through a breach in a door, a roof, or a wall or other area of a structure to support and stabilize the device when in use.

The central portion or section serves as the common conduit for delivery of the fire retardants or fire suppressors from the inlet pipes to the diffuser nozzle, which is directed in the direction of the fire. The central portion or section, for example, a pipe, may have a length from about 12″ to about 36″ and an inner core diameter from about 38.1 mm to about 254 mm. The fire retardants or fire suppressors may be retardant fluids, for example, water and a gas, for example, ambient air or ambient air supplemented with a gas including, but not limited to, nitrogen, argon, helium, or carbon dioxide.

The central portion or section comprises a shutoff valve and a handle or a grip individually disposed thereon or comprises a shutoff valve and grip combination, as is known in the art, coupled to the central section. Alternatively, in addition to the central or first shutoff valve, the Y-connector comprises a pair of second shutoff valves in fluid communication therewith, that is, one shutoff valve in the pair in fluid communication with one arm of the Y-connector and the other shutoff valve in fluid communication with the other arm. As is known in the art each shutoff valve is adapted to independently cease or to independently control the rate of flow of the fire retardants through the device thereby enabling a user to vary the proportion of fluids and/or gases per cubic volume of the central portion or central section and/or in the Y-connector.

Particularly, the inlets are made of a flexible material or a rigid material as is known in the art depending upon the fire retardant carried in each. The flexible or rigid material may be chemically resistant to the fire retardants. The inlets may be interiorly coated with a liner resistant to, but not limited to, chemicals, temperature, mold, mildew, and abrasion. The inlets may have any suitable length that gives a user access to the fire, for example, but not limited to, about 50 feet to about 200 feet. The fire retardants may be delivered to the inlets by any means standard in the art. Water may be delivered via a city water supply, such as a fire hydrant, or siphoned from a body of water near to the fire, such as a reservoir, a lake, a river, or ocean. The fire retardant gas, for example, air or air mixture, may be delivered using a compressor, a pressurized container or any other suitable means well known in the art and available commercially. One inlet may fluidly deliver water or both inlets may fluidly deliver water and a gas fire retardant to the Y-connector which fluidly delivers the fire retardant(s) to the central portion or central section of the device and subsequently to the diffuser nozzle for use against a fire.

The diffuser may comprise a diffuser nozzle or a diffuser nozzle and venturi combination. The venturi may be disposed within the diffuser nozzle or disposed immediately distal to the diffuser nozzle in fluid communication with the central portion or section. A plurality of orifices on the proximal end of the diffuser nozzle diffuse the fire retardants introduced via the inlets and propelled under pressure through the Y-connector and central portion or central section to the diffuser. A spray or mist is produced. The diffuser nozzle may be adjustable as to the characteristics of the spray or mist delivered to the fire. The diffuser nozzle may have an overall length of about 3 in. to about 10 inch and an inner bore diameter of about 38.1 mm to about 254 mm. The diffuser nozzle and venturi are well-known in the art and commercially available.

Also provided herein is a barrier-penetrating fire suppression system adapted to breach a barrier and to deliver the fire retardants or fire suppressors as described herein to extinguish a fire behind the barrier. The system is adapted to be utilized with any vehicle platform boom used by a fire department to breach a barrier at an elevated location. The barrier is any barrier that must be breached or broken to enable access to the fire in an interior space. The barrier may be, but is not limited to a roof, a wall and a window. Generally, fire suppression system comprises a penetrator assembly removably mounted to or removably attached to a boom arm and piston combination attached to the vehicle platform boom. The penetrator assembly may have an overall length of about 48 inches to about 72 inches. As described herein, the components of the fire suppression system are made of a material or combination of materials adapted to sustain a pressure from about 500 psi to about 1,000 psi as are known in the art.

The penetrator assembly has an injector head or penetrator injector head comprising a driver motor or penetrator driver motor and a hollow striker shaft disposed within the interior of the injector head and through the injector head to extend from the front and back thereof. A hollow delivery line is disposed within the hollow striker shaft. The hollow striker comprises a piercing nozzle removably attached at its proximal end and a manifold at its distal end such that the hollow delivery line is in fluid communication with both the piercing nozzle and the manifold. The manifold comprises two inlets distal to the distal end of the hollow striker shaft to which are removably attached to a pair of feed lines that supply the water and fire retardant gas to the manifold. Supply to the manifold via the feed lines is as described herein for the fire control device and fire suppression device.

The piercing nozzle facilitates breaching the barrier by one or more impacts thereon and is made of any material suitable to withstand the impacts on the barrier. The piercing nozzle comprises a tip at the proximal end for breaching and a plurality of nozzle ports or orifices circumferentially disposed distal to the proximal end. The nozzle ports are in fluid communication with the proximal end of the hollow delivery line.

The hollow striker shaft contains a gear drive mechanically coupled to the injector head and a linear gear track engaged with the gear drive. The injector head comprising the penetrator driver motor may be operated/actuated by hydraulic or electrical means to engage the gear drive to move the linear gear track in a reciprocal or forward and backward motion. This results in the forward movement of the hollow striker shaft with sufficient force that enables the piercing nozzle to breach the barrier to extinguish the fire and to move the hollow striker shaft backward to withdraw the piercing nozzle back through the breach after the fire is extinguished.

The boom arm and piston combination is removably mounted or removably attached to the bottom of the penetrator injector head via means standard in the art thereby securing the penetrator assembly to the vehicle platform boom. The boom arm and piston combination is electrically operated such that the movement of the piston enables the penetrator assembly to be moved freely in an upward or downward direction to orient the hollow piercing nozzle perpendicularly to the barrier. The boom arm and the piston are each made of materials suitable to support the penetrator assembly and suitable to withstand the pressure used to propel the fire retardants through the components thereof.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

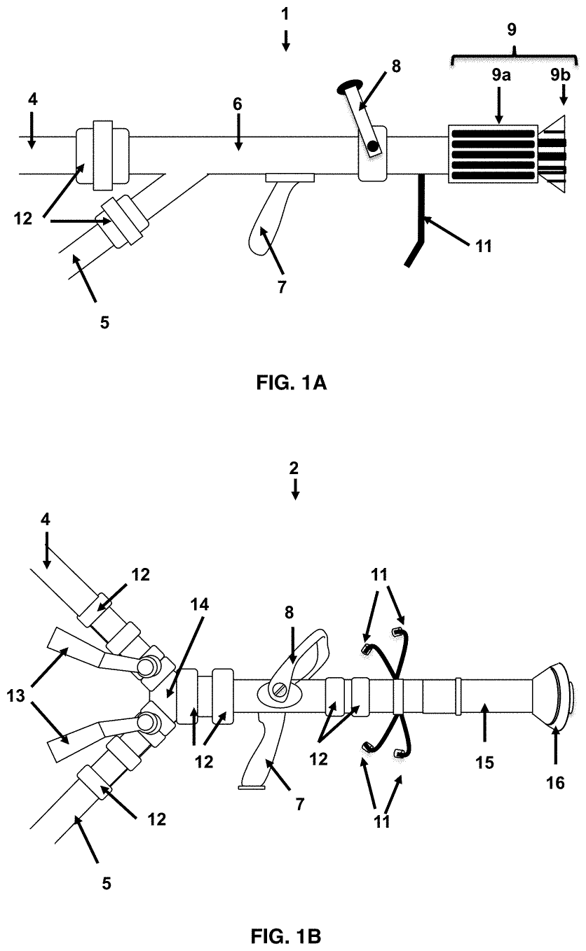

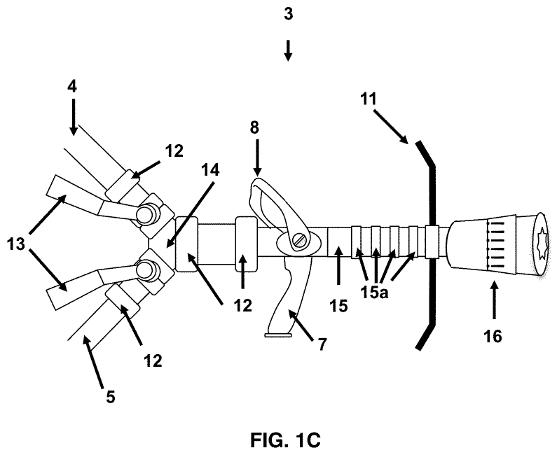

FIG. 1A is a side view of a fire suppression device 1. The cylindrical pipe 6 is Y-shaped at its distal end with a water inlet 4 and a gas inlet 5 fluidly coupled to the arms of the Y with couplers 12. A diffuser 9 comprising a venturi 9a and diffuser nozzle 9b are in fluid communication with the pipe at the proximal end thereof. A first shutoff valve 8 controls the flow of the water and/or gas through the pipe to the venturi and diffuser nozzle. A hook 11 disposed between the first shutoff valve and the venturi and a grip or handle 7 disposed between the first shutoff valve and the gas inlet each are secured to and depend from the cylindrical pipe. The hook provides stability to the device when braced against or across a structure or other object, for example, an interior wall such as beneath a window sill or other opening or hole through a wall or other barrier, to direct water into a building through whether or not a user is holding the device by the handle. The force created in opposition to the forward force of the water exiting the nozzle braces the hook against the interior wall.

With continued reference to FIG. 1A, FIG. 1B is a side view of another configuration of a fire suppression device 2. The device comprises a proximal diffuser section comprising a cylindrical pipe 15 in fluid communication with diffuser nozzle 16. A first shutoff valve 8 and grip or handle 7 combination section is coupled in fluid communication by couplers 12 at the proximal end thereof to the distal end of the cylindrical pipe. A Y-connector 14 or a manifold section is coupled in fluid communication by couplers 12 at the proximal end thereof to the distal end of the shutoff valve and grip combination. The Y-connector has a water inlet 4 and a gas inlet 5 fluidly coupled to the distal ends of the arms of the Y with couplers 12 and has a pair of second shutoff valves 13 disposed on the proximal ends of the arms of the Y. The second shutoff valves control the flow of the water and/or gas through to the diffuser nozzle. A plurality of hooks 11 circumferentially depend and extend from the cylindrical pipe to brace against an interior surface of a building or other structure. For example, when positioned through a breach in a building, structure or other barrier, the hooks depending from the pipe brace below the breach and the hooks extending from the pipe brace above the breach. The hooks are effective if only the depending hooks, such as utilized in FIG. 1A, or only the extending hooks are utilized.

With continued reference to FIG. 1B, FIG. 1C is a side view of yet another configuration of the fire suppression device 3. For device 3, the proximal end of the shutoff valve 8 and grip 7 combination is in direct fluid connection with the distal end of the cylindrical pipe 15. A pair of hooks 11 depend from the cylindrical pipe in opposite relation one to the other and are utilized as described in FIG. 1B. A plurality of protective strips are circumferentially disposed along the cylindrical pipe between the pair of hooks and the proximal end of the shutoff valve and grip combination. The strips protect or cushion from damage that portion of the device that rests on a sill or ledge or other section of a barrier that has been breached, for example, when in use.

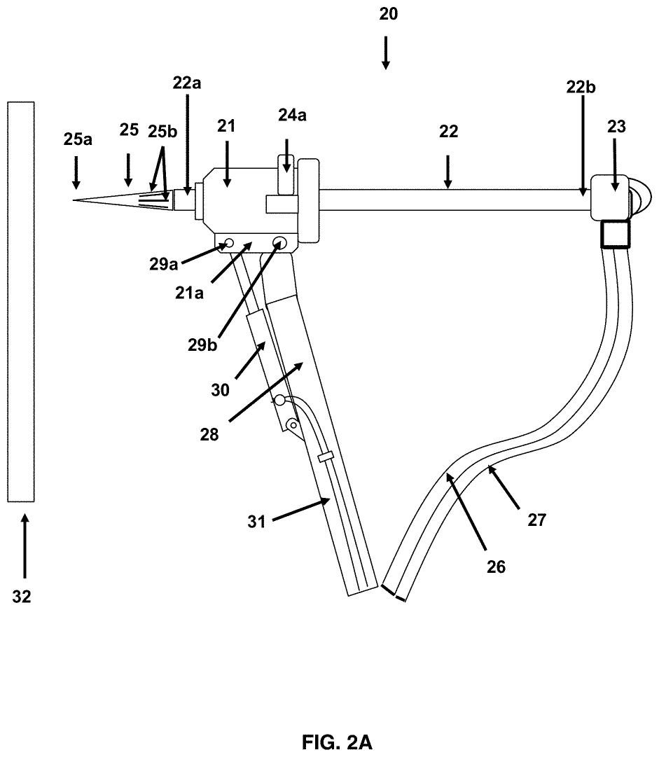

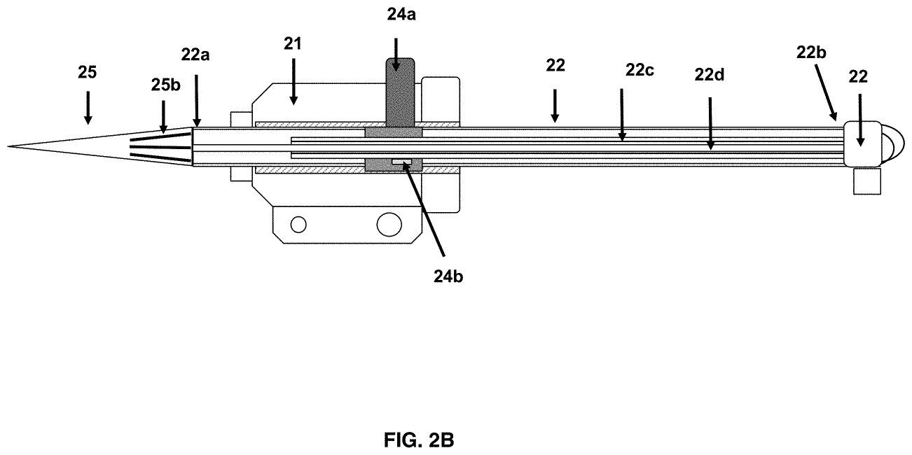

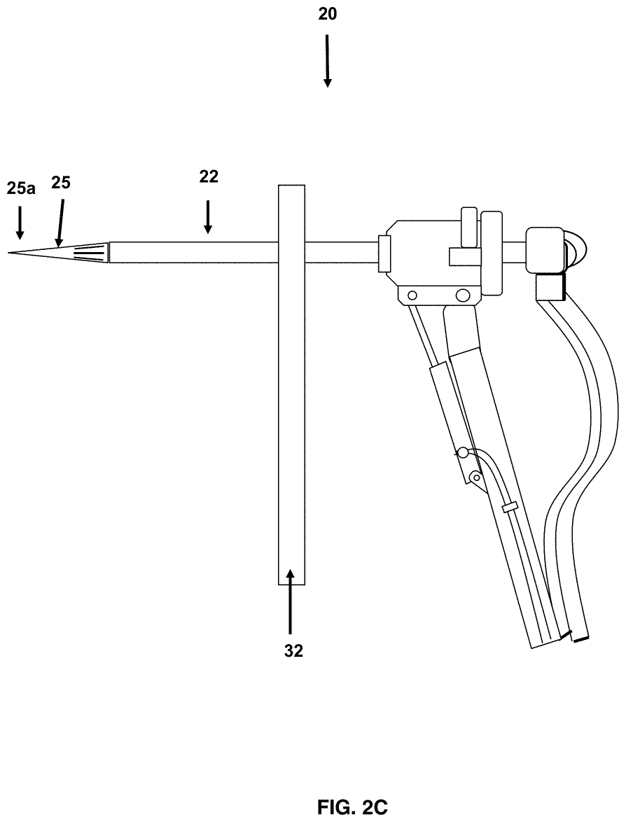

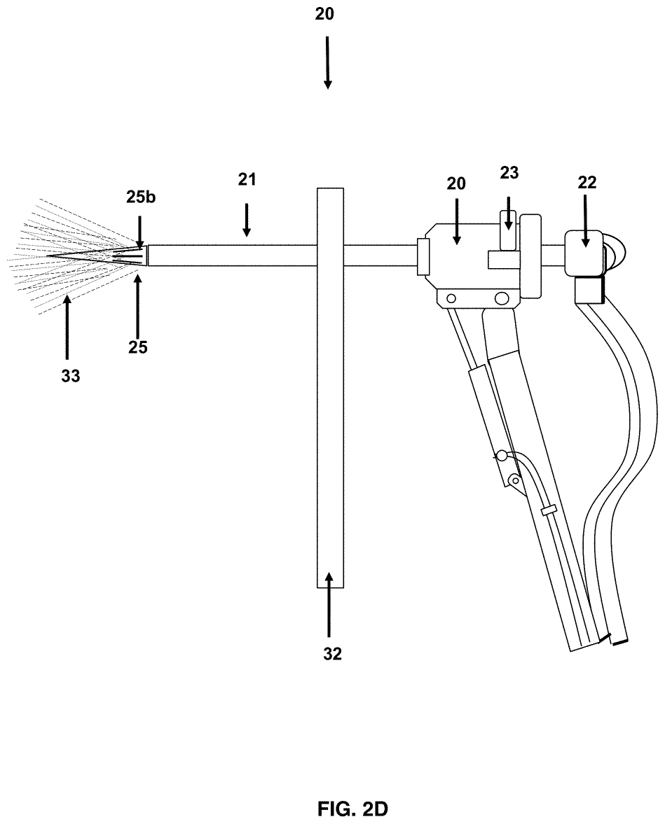

FIG. 2A is a side view of the penetrator assembly 20 of a barrier-penetrable fire suppression system. The penetrator assembly has an injector head 21 through which a hollow striker shaft 22 is movably and transversely disposed and a penetrator driver motor 24a is attached on the outer surface thereof to drive the hollow shaft in a linear or reciprocating motion (see FIG. 2B). The hollow striker shaft has a piercing nozzle 25 attached to the proximal end 22a 22a of the striker shaft and a manifold 23 attached at the distal end 22b. The piercing nozzle has a proximal end 25a adapted to pierce through a barrier 32 during a fire and a plurality of nozzle ports 25b circumferentially disposed thereon through which a fire suppressing fluid is delivered from a proximal end of a hollow delivery line disposed within the hollow striker shaft (see FIG. 2B). A pair of feed lines 26,27 adapted to feed a fire suppressing fluid, for example, water and a gas propellant, for example air, are disposed within the manifold such that the proximal ends of the feed lines are each in fluid connection with the distal end of the hollow delivery line.

The injector head 21 has a mount 21a at the base thereof onto which a combination of an arm 28 and a piston 30 are mounted at 29b and at 29a, respectively. The arm is part of a vehicle boom platform. The piston enables a user to move the penetrator assembly in an upward or downward direction using electrical controls 31 for orientation of the piercing nozzle perpendicular to the barrier.

With continued reference to FIG. 2A, FIG. 2B is a cross-sectional view of the injector head 21 and hollow striker shaft 22. A linear gear track 22c is disposed within and along the interior of the hollow striker shaft 22 and in a concentric relationship therewith. The linear gear track is mechanically and movably coupled with a gear drive 24b movably connected to the penetrator driver motor 24a and enables linear reciprocal movement, i.e., forward movement when deploying and backward movement when retracted, of the penetrator assembly during deployment. A hollow delivery line 22d is disposed within and along the cylindrical linear gear and in a concentric relationship therewith. The delivery line is in fluid communication with the plurality of nozzle ports 25b on the piercing nozzle 25 at the proximal end 22a of the hollow striker shaft 22 and with the manifold 23 at the distal end 22b of the hollow striker shaft.

With continued reference to FIGS. 2A-2B, FIG. 2C is a side view of the penetrator assembly 20 with the striker shaft 22 in a deployed position. The proximal end 25a of the piercing nozzle 25 breached the barrier 32 when the gear drive 24b engages the linear gear 22c (see FIG. 2B) and deploys the striker shaft perpendicularly to the barrier.

With continued reference to FIGS. 2A-2C, FIG. 2D shows the penetrator assembly 20 as deployed in FIG. 2C with a spray 33 or mist of water propelled from the plurality of nozzle ports 25b on the piercing nozzle 25. A mixture of water and air under pressure flows through feeds 26,27 into manifold 23, through the hollow delivery line 22d, into the piercing nozzle, and out the nozzle ports.

What is claimed is:

1. A fire suppression device comprising
a pipe with a proximal end and a distal end;
a diffuser removably attached to and in fluid communication with the proximal end of the pipe;
a first shutoff valve disposed in fluid communication with the pipe distal to the diffuser;
at least one hook attached to the pipe between the diffuser and the shutoff valve; and
a Y-connector formed at the distal end of the pipe comprising an inlet coupled to each arm of the Y-connector and in fluid communication therewith.

2. The fire suppression device of claim 1, further comprising a second shutoff valve disposed in fluid communication with each inlet coupled to the arm of the Y-connector or with each arm thereof.

3. The fire suppression device of claim 1, further comprising a handle depending from the pipe between the shutoff valve and the Y-connector.

4. The fire suppression device of claim 1, wherein the diffuser comprises a venturi and a diffuser nozzle.

5. The fire suppression device of claim 1, wherein the pipe has an inner bore with a diameter of about 38.1 mm to about 254 mm.

6. The fire suppression device of claim 1, wherein each inlet has an inner bore with a diameter equal to the diameter of the inner bore of the pipe.

7. The fire suppression device of claim 1, wherein one inlet is a water inlet and the other inlet is an air inlet.

8. The fire suppression device of claim 1, wherein the device is constructed from a material that withstands a pressure of about 500 psi to about 1,000 psi.

9. A fire control device comprising:
in fluid communication:
a diffuser section with a proximal and distal end;
a shutoff valve and grip combination with a proximal end disposed at the distal end of the diffuser section and a distal end; and
a Y-connector with a proximal end disposed at the distal end of the shutoff valve and grip combination and a distal end.

10. The fire control device of claim 9, said diffuser section comprising:
a cylindrical pipe comprising a proximal end and a distal end;
a diffuser nozzle removably attached to and in fluid communication with the proximal end of the cylindrical pipe; and
a plurality of hooks attached circumferentially to the cylindrical pipe.

11. The fire control device of claim 10, further comprising a plurality protective strips disposed along the cylindrical pipe between the plurality of hooks and the shutoff valve and grip combination.

12. The fire control device of claim 10, wherein the diffuser nozzle further comprises a venturi disposed therein.

13. The fire control device of claim 10, wherein the cylindrical pipe has an inner bore with a diameter of about 38.1 mm to about 254 mm.

14. The fire control device of claim 10, said Y-connector comprising:
a coupler attached to proximal end thereof and a coupler attached to the distal end of each arm of the Y-connector;
an inlet with a coupler attached to a proximal end thereof removably coupled with the coupler at the distal end of each arm of the Y-connector and in fluid communication therewith; and
a second shutoff valve disposed on each arm of the Y-connector and in fluid communication therewith.

15. The fire control device of claim 14, wherein the diffuser section further comprises a coupler attached at the distal end thereof and the shutoff valve and grip combination comprises a first shutoff valve disposed in fluid communication between the diffuser section and the Y-connector and a coupler attached at the proximal end thereof and a coupler attached at the distal end thereof, said shutoff valve and grip combination coupled with the coupler at the distal end of the diffuser section and at the proximal end of the Y-connector.

16. The fire control device of claim 14, wherein the shutoff valve and grip combination comprises a first shutoff valve disposed in fluid communication between the diffuser section and the Y-connector and a coupler attached at the distal end thereof, said shutoff valve and grip combination in direct fluid contact with the distal end of the diffuser section and coupled with the coupler at the proximal end of the Y-connector.

17. The fire control device of claim 14, wherein each inlet has an inner bore with a diameter equal to the diameter of the inner bore of the pipe.

18. The fire control device of claim 14, wherein one inlet is a water inlet and the other inlet is an air inlet.

19. A barrier-penetrating fire suppression system comprising:
a penetrator assembly comprising:
an injector head comprising a hollow interior portion with an open proximal front end and an open distal back end disposed transversely therewithin;
a penetrator driver motor disposed on the injector head;
a hollow striker shaft with an open proximal end and an open distal end disposed within the hollow interior portion of the injector head and in a mechanical relationship with the penetrator driver motor, said hollow striker shaft extending from both the open proximal front end and from the open distal back end thereof;
a piercing nozzle in fluid communication with the open proximal end of the hollow striker shaft and removably attachable therefrom; and
a manifold in fluid communication with the open distal end of the hollow striker shaft; and
a boom arm and piston combination removably mounted to the injector head at proximal ends thereof and attached to a vehicle platform boom at distal ends thereof, said boom arm and piston combination electrically operable.

20. The barrier-penetrating fire suppression system of claim 19, wherein the hollow striker shaft comprises:
a gear drive disposed therein and coupled with the penetrator driver motor;
a linear gear track interiorly disposed along the hollow striker shaft and engaged with the gear drive; and
a hollow delivery line disposed therewithin with a proximal end in fluid communication with the piercing nozzle and a distal end in fluid communication with the manifold.

21. The barrier-penetrating fire suppression system of claim 20, wherein the hollow delivery line has an inner bore diameter of about 38.1 mm to about 254 mm.

22. The barrier-penetrating fire suppression system of claim 20, wherein the piercing nozzle comprises:
a proximal end adapted to pierce a barrier; and
a plurality of nozzle ports disposed circumferentially thereon in fluid communication with the hollow delivery line.

23. The barrier-penetrating fire suppression system of claim 22, wherein the barrier is a wall, a roof or a window.

24. The barrier-penetrating fire suppression system of claim 20, wherein the manifold comprises a pair of feed lines each with a proximal end in fluid communication therewith and each removably attachable thereto.

25. The barrier-penetrating fire suppression system of claim 24, wherein one of the pair of feed lines is a water feed line and the other of the pair of feed lines is an air feed line.

26. The barrier-penetrating fire suppression system of claim 19, wherein said penetrator assembly is constructed from a material that withstands a pressure of about 500 psi to about 1,000 psi.
